(19) United States
(12) Patent Application Publication
(10) Pub. No.: US 2021/0188518 A1
(43) Pub. Date: Jun. 24, 2021

(54) MEMBRANE APPARATUS AND METHOD FOR USE IN SHIPPING CONTAINER

(71) Applicant: AVCATECH LABORATORIES PTY LTD, Esendon Fields (AU)

(72) Inventors: Sanjay SAVUR, Victoria (AU); Lee James JONES, Victoria (AU)

(21) Appl. No.: 17/271,388

(22) PCT Filed: Aug. 27, 2019
(86) PCT No.: PCT/AU2019/050910

§ 371 Date: Feb. 25, 2021

(30) Foreign Application Priority Data
Aug. 27, 2018 (AU) 2018903149

(51) Int. Cl. B65D 81/24; B01D 53/22; A23B 7/148; A23L 3/3418; B65D 81/20

(52) U.S. Cl. CPC B65D 81/245; B01D 53/228; B65D 81/2076; A23L 3/3418; A23B 7/148

(57) ABSTRACT

This invention relates to a method of, and apparatus for, controlling gas composition within a refrigerated container, such as to extend the life of perishable goods during transport within the refrigerated container. The invention involves contacting a blended airstream with a membrane system. The blended air stream is formed from a first air stream withdrawn from the refrigerated container and a second air stream obtained from an ambient environment external to the refrigerated container. The invention also relates to a refrigerated container, a membrane system, a gas membrane separation module and method for installing the apparatus, membrane system or gas membrane separation module into or onto a refrigerated container.

### FIELD OF THE INVENTION

The present invention relates generally to a method of, and apparatus for, controlling gas composition within a refrigerated container, such as to extend the life of perishable goods during transport within the refrigerated container.

### BACKGROUND OF THE INVENTION

In order to prolong the storage life of perishable goods (such as fruit and vegetables) stored in sealed controlled atmosphere containers during transportation or storage it is generally important to control at least some environmental conditions within the container. This is because environmental parameters, for example temperature and gas composition within the container, affect the rate of respiration and deterioration of goods after harvest.

The conventional method of extending storage life of produce has been to refrigerate the sealed container and to reduce carbon dioxide levels (as carbon dioxide is generated by respiring produce), while maintaining a controlled atmosphere within that container (e.g. maintaining oxygen and nitrogen at desired levels). However, if the carbon dioxide concentration rises too high, then the perishable product may be damaged, resulting in even more rapid deterioration than might occur if no treatment was applied. Damage may also occur if the oxygen concentration is reduced too much. However, conversely higher concentrations of oxygen promote respiration which is also undesirable.

Consequently it is desirable to be able to adjust the composition of the atmosphere within the sealed chamber and apparatus for adjusting the atmosphere in the chamber has accordingly been developed.

Applicant's invention described in WO 20001023350 entitled ‘Apparatus for controlled venting of a chamber’ proposed a new approach of maintaining the controlled environment within a substantially sealed chamber containing respiring produce. The method is carried out without monitoring the carbon dioxide level in the sealed chamber and involved monitoring the oxygen level in the chamber and admitting ambient air into the sealed chamber when the oxygen level is detected to have fallen below an oxygen set point. Carbon dioxide is removed from the sealed chamber at a predetermined rate by way of a selected quantity of carbon dioxide absorbing material stored within the sealed container. The predetermined rate in the process is selected before the storage/journey such that the carbon dioxide concentration within the sealed chamber will not exceed a predetermined amount.

Other known methods for controlling the atmosphere within a sealed container utilise a permeable membrane within the sealed container which membrane is selective for removing certain gases while retaining others. That is, the membrane allows some gases to pass through, whilst excluding or minimising the passage of certain other gases. The selective membrane is installed in the sealed container as a liner layer which defines a buffer zone which can be opened to the ambient air outside the sealed container, or manipulated in other ways. Imposing a partial pressure difference across the membrane has the effect of selective removal of gases into the buffer zone. Such techniques advantageously avoid the need for carbon dioxide absorbing materials. Typically, with these methods, fresh ambient air is leaked into the container, such as through an air vent, to replenish the air removed via the membrane. There are a number of disadvantages with this approach including: high energy consumption to cool the fresh ambient air and a lack of control over the air composition of the internal environment within the container, particularly with respect to oxygen.

Applicant's invention described in WO 2014/066952 entitled ‘Improvements in control of gas composition within a container’ describes a method controlling the atmosphere within a substantially sealed container by removing carbon dioxide from the sealed chamber of a shipping container using a membrane system. In this publication, the Applicant proposed a method of controlling the atmosphere in which air from within the sealed chamber was passed through the membrane system to remove CO₂ whilst the air pressure inside the chamber was actively monitored. In response to a change in pressure, a controller would actuate an inlet valve on the shipping container to introduce external air into the container in an amount to result in the air within the sealed chamber having a set gas composition. Whilst this method provides advantages over the method described above, further improvements in energy efficiency and control over the internal composition of the air inside the container are desirable.

The present invention provides in various forms a new method of controlling the environment in a container, a new container apparatus, and apparatus for controlling the environment in the container.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In a first aspect of the invention, there is provided a method for controlling the atmosphere within a refrigerated shipping container containing respiring produce, the method including:

blending a first air stream withdrawn from an internal environment within the refrigerated shipping container with a second air stream obtained from an ambient environment external to the shipping container to form a blended air stream;

subjecting the blended air stream to a membrane separation process using a separation membrane having greater relative selectivity for CO₂ and O₂ than N₂ to provide an N₂-rich gas stream; and returning the N₂-rich gas stream to the internal environment.

The present invention thus advantageously provides a means for removing CO₂ and O₂ from the internal environment and offsetting this with the addition of N₂. The blending of N₂ with the first air stream after the first air stream has been withdrawn from the internal environment and before the first stream to offset the removal of CO₂ and O₂ results in the internal environment having low concentrations of CO₂ and O₂ which reduces the rate of respiration and provides enhanced storage for the produce during transport. Furthermore, because N₂-rich gas stream can be operated at a volumetric flow rate to offset the lost CO₂ and O₂, the requirements to introduce fresh ambient air are minimised reducing the energy needed to maintain an internal refrigerated environment.

As discussed above, the membrane has a greater relative selectivity for CO₂ and O₂ than N₂. This is intended to mean that the membrane possesses a selectivity which allows carbon dioxide gas and oxygen to permeate through the membrane at a higher rate than nitrogen.

In an embodiment, the N₂-rich gas stream has a N₂ vol % that is greater than the N₂ vol % in the blended aft stream.

In an embodiment, the N₂-rich gas stream has a N₂ vol % that is greater than the N₂ vol % of air (e.g. greater than 78 vol % on a dry air basis). In one or more forms, the N₂-rich gas stream has a N₂ vol % of from about 80 vol % and up to about 98 vol %. Preferably, the N₂ vol % is from about 82 vol %. More preferably, the N₂ vol % is from about 84 vol %. Alternatively, or additionally, it is preferred that the N₂ vol % is up to about 96 vol %. More preferably, the N₂ vol % is up to about 94 vol %.

In an embodiment, the first air stream is a cooled CO₂-rich air stream. By CO₂-rich, it is meant that the first air stream has a CO₂ vol % that is higher than air (e.g. greater than about 0.04 vol % on a dry air basis). Typically, the cooled CO₂-rich air stream has a CO₂ content of 2 to 10 vol %. The skilled person will appreciate that the first air stream contains N₂ (about 78 vol % on a dry air basis noting that N₂ does not participate in the respiration reaction) and a reduced amount of O₂ relative to dry air (e.g. less than 21 vol %) due to the consumption of O₂ during respiration. In one or more embodiments, the cooled CO₂-rich air stream has an O₂ content of 2 to 10 vol %.

It will be appreciated that as the second air stream is obtained from the ambient environment, the second air stream will have a gas composition of air, e.g. dry air has a composition of about 78 vol % N₂, about 21 vol % O₂, about 0.04 vol % CO₂, and a remainder of other gases.

An advantage of the various aspects generally described herein, is that the composition of the internal environment within the refrigerated container can be set, e.g. it is possible to balance the operation of the membrane, such as by controlling flows of the various gas streams and/or internal pressure of the container to maintain a desired container gas composition in terms of at least CO₂, O₂, and N₂.

In an embodiment, the container air has a higher proportion of CO₂ than the N₂-rich gas stream, such that the method is a method of reducing the CO₂ concentration within the refrigerated shipping container.

In an embodiment, the N₂-rich gas stream is fed into the container at a rate sufficient to maintain a neutral or positive pressure difference between the internal environment and the external environment. An advantage of this arrangement is that it minimises or prevents ingress of ambient air into the container, which can be important as the container ages and the likelihood of air leakage into the container increases. However, it will be appreciated that in other embodiments, the N₂-rich gas stream is fed into the container at a rate to provide a negative pressure difference between the internal environment and the external environment.

In an embodiment, the internal environment of the refrigerated container is maintained at a CO₂ concentration of from about 2 up to about 10 vol %. Preferably, the CO₂ concentration is from about 3 vol %. More preferably, the CO₂ concentration is from about 4 vol %. Most preferably, the CO₂ concentration is from about 5 vol %. Alternatively, or additionally, it is preferred that the CO₂ concentration is up to about 9 vol %. More preferably, the CO₂ concentration is up to about 8 vol %.

In an embodiment, the internal environment of the refrigerated container is maintained at an O₂ concentration of from about 2 up to about 10 vol %. Preferably, the O₂ concentration is from about 3 vol %. Alternatively, or additionally, the O₂ concentration is up to about 9 vol %. Preferably, the O₂ concentration is up to about 8 vol %. More preferably, the O₂ concentration is up to about 7 vol %. Most preferably, the O₂ concentration is up to about 6 vol %,

In an embodiment, the internal environment of the refrigerated container is maintained at a N₂ concentration of from about 80 up to about 95 vol %. Preferably, the N₂ concentration is from about 82 vol %. Alternatively, or additionally, the N₂ concentration is up to about 84 vol %. Preferably, the N₂ concentration is up to about 93 vol %. More preferably, the N₂ concentration is up to about 91 vol %. Most preferably, the N₂ concentration is up to about 89 vol %.

The skilled person will appreciate that the composition of the internal environment may be controlled or set by the flow rate of the N₂-rich gas stream and/or a rate at which container air is leaked from the internal environment to the external environment. Thus, in an embodiment, the refrigerated shipping container includes a vent, and the method includes leaking a portion of the container air through the vent.

In one form of the above embodiment, the N₂-rich gas stream is fed into the container and/or container air is leaked from the internal environment at a rate sufficient to maintain a CO₂ concentration within the internal environment of from about 2 up to about 10 vol %. Preferably, the CO₂ concentration is from about 3 vol %. More preferably, the CO₂ concentration is from about 4 vol %. Most preferably, the CO₂ concentration is from about 5 vol %. Alternatively, or additionally, it is preferred that the CO₂ concentration is up to about 9 vol %. More preferably, the CO₂ concentration is up to about 8 vol %.

In one form of the above embodiment, the N₂-rich gas stream is fed into the container and/or container air is leaked from the internal environment at a rate sufficient to maintain an O₂ concentration within the internal environment of from about 2 up to about 10 vol %. Preferably, the O₂ concentration is from about 3 vol %. Alternatively, or additionally, the O₂ concentration is up to about 9 vol %. Preferably, the O₂ concentration is up to about 8 vol %. More preferably, the O₂ concentration is up to about 7 vol %. Most preferably, the O₂ concentration is up to about 6 vol %.

In an embodiment, the N₂-rich gas stream is lean in CO₂ and O₂. By lean in CO₂ and O₂, it is meant that the N₂-rich gas stream has a CO₂ and O₂ vol % that is lower than the vol % in the blended air stream. In a preferred form, the CO₂ and/or O₂ vol % that is lower than the vol % in air (e.g. less than 0.4 vol % CO₂ and/or less than 21 vol % O₂ on a dry air basis).

In an embodiment, the step of subjecting the blended air stream to the membrane separation process includes:
contacting the blended air stream with the membrane to produce a CO₂-, O₂-rich permeate stream and a retentate stream that is the N₂-rich gas stream; and
exhausting the CO₂-, O₂-rich permeate stream to the external environment.

In an embodiment, the first air stream and the second air stream are blended in a ratio of from about 5:1 to about 25:1. Preferably, the ratio is to about 20:1. More preferably, the ratio is to about 15:1. Alternatively, or additionally, it is preferred that the ratio is from about 7:1. More preferably, the ratio is from about 8:1. By way of example, in one form, the ratio is from about 8:1 to about 15:1.

In an embodiment, the second aft stream has a volumetric flowrate that is sufficient to provide a volumetric flow rate of the N₂-rich gas stream that is from 80% and up to 120% of a volumetric flow rate of the first air stream. Preferably, the volumetric flow rate is from 85% of the volumetric flow rate of the first air stream. More preferably, the volumetric flow rate is from 90% of the volumetric flow rate of the first air stream. Even more preferably, the volumetric flow rate is from 95% of the volumetric flow rate of the first air stream. Most preferably, the volumetric flow rate is from or about 100% of the volumetric flow rate of the first air stream. Alternatively, or additionally, it is preferred that the volumetric flow rate is up to 115% of the volumetric flow rate of the first air stream. More preferably, the volumetric flow rate is up to 110% of the volumetric flow rate of the first air stream. Most preferably, the volumetric flow rate is up to 105% of the volumetric flow rate of the first air stream. By way of example, in one form, the volumetric flow rate of the N₂-rich stream is from 100% and up to 110% of the volumetric flow rate of the first air stream.

In an embodiment, the membrane has a CO₂:N₂ selectivity ratio of at least 5:1. Preferably, the membrane has a CO₂:N₂ selectivity ratio of at least 7:1. More preferably, the membrane has a CO₂:N₂ selectivity ratio of at least 10:1. Most preferably, the membrane has a CO₂:N₂ selectivity ratio of at least 14:1. While there is no particular upper limit to the CO₂:N₂ selectivity ratio, practically the membrane may have a CO₂:N₂ selectivity ratio of up to 50:1.

In an embodiment, the membrane has an O₂:N₂ selectivity ratio of at least 1.5:1. Preferably, the membrane has an O₂:N₂ selectivity ratio of at least 2:1. Even more preferably, the membrane has an O₂:N₂ selectivity ratio of at least 3:1. While there is no particular upper limit to the O₂:N₂ selectivity ratio, practically the membrane may have an O₂:N₂ selectivity ratio of up to 20:1.

In further forms of the above embodiment, the membrane has a selectivity which allows carbon dioxide to permeate through the membrane at a higher rate than oxygen. In one embodiment, the membrane has a CO₂:O₂ selectivity ratio of at least 5:2. Preferably, the membrane has a CO₂:O₂ selectivity ratio of at least 4:1. More preferably, the membrane has a CO₂:O₂ selectivity ratio of at least 5:1. While there is no particular upper limit to the CO₂:O₂ selectivity ratio, practically the membrane may have a CO₂:O₂ selectivity ratio of up to 15:1.

In an embodiment, the refrigerated shipping container: (i) does not include a vent, or (ii) is operated with the vent set to a substantially dosed position, or (iii) is operated with the vent set to a position such that air flow through the vent is less than that required to replace the first air stream that is withdrawn from the internal environment.

In a second aspect of the invention, there is provided a refrigerated shipping container configured to be operated according to the method of the first aspect of the invention and/or embodiments thereof.

In a third aspect of the invention, there is provided a refrigerated shipping container configured to transport respiring produce, the refrigerated shipping container including:

a gas membrane separation module including:
a first gas inlet open to an internal environment within the refrigerated shipping container configured to draw a first air stream from the internal environment;
a second gas inlet open to an ambient environment external to the refrigerated shipping container and configured to draw a second air stream from the ambient environment;
a membrane unit including:
   a membrane having greater relative selectivity for CO₂ and O₂ than N₂ and configured to provide an N₂ rich gas stream; and
   an inlet to the membrane configured to receive a blended gas stream from the first gas inlet and the second gas inlet,
   an outlet from the membrane open to the internal environment configured to return the N₂ rich gas stream to the internal environment.

In an embodiment of the second or third aspects, the refrigerated shipping container further includes:

gas circulation means configured to:
draw the first aft stream through the first inlet,
draw the second gas stream through the second inlet,
contact the blended aft stream with the membrane, and
return the N₂-rich gas stream to the internal environment.

In an embodiment of the second or third aspects, the refrigerated shipping container: (i) does not include a vent, or (ii) includes a vent set to a substantially closed position, or (iii) includes a vent configured to an open position such that air flow through the vent is less than that required to replace the first air stream that is withdrawn from the internal environment.

In a fourth aspect of the invention, there is provided a gas membrane separation module, the gas membrane separation module including:

a mount for installing the gas membrane separation module into or onto a refrigerated shipping container;

a first gas inlet open to an internal environment within the refrigerated shipping container configured to draw a first air stream from the internal environment;

a second gas inlet open to an ambient environment external to the refrigerated shipping container and configured to draw a second air stream from the ambient environment;

a membrane unit including:
a membrane having greater relative selectivity for CO₂ and O₂ than N₂ and configured to provide an N₂-rich gas stream; and
an inlet to the membrane configured to receive a blended gas stream formed from the first air stream and the second air stream,
an outlet from the membrane open to the internal environment configured to return the N₂-rich gas stream to the internal environment.

In an embodiment, there is provided the gas membrane separation module when used in a refrigerated shipping container.

In a fifth aspect of the invention, there is provided a method including installing the gas separation module of the fourth aspect of the invention and/or embodiments thereof into or onto a refrigerated shipping container.

It will be appreciated that in one or more forms of the invention, the membrane system includes a retentate side gas circulation system. The retentate side gas circulation system may include one or more pumps, such as one or more pumps located upstream of the CO₂ selective membrane and/or one or more pumps located downstream of the CO₂ selective membrane. While variable drive speed pumps may be used, it is preferred that each pump is operated at a single speed. Given this, it is further preferable that each pump is a single speed pump.

In an embodiment, the membrane system includes a single pump retentate side gas circulation system for passing the cooled CO₂-rich air stream to the CO₂ selective membrane and returning the cooled CO₂-lean air stream to the internal environment. In one form of this embodiment, the single pump is located upstream of the CO₂ selective membrane and the step of passing the cooled CO₂-rich air through the CO₂ selective membrane includes: providing air to the CO₂ selective membrane under positive pressure. In an alternative form of this embodiment, the single pump is located downstream of the CO₂ selective membrane and the step of passing the cooled CO₂-rich air stream through the CO₂ selective membrane includes drawing air through the CO₂ selective membrane under negative pressure.

It will be appreciated that in one or more forms of the invention, the membrane system includes a permeate side gas circulation system, also commonly referred to as a sweep gas circulation system. In such embodiments, the CO₂-rich permeate stream is a CO₂-rich sweep stream. The permeate side gas circulation system may include one or more sweep pumps, such as one or more sweep pumps located upstream of an inlet to a permeate side of the CO₂ selective membrane and/or one or more sweep pumps located downstream of an outlet to the permeate side of the CO₂ selective membrane. Although it is preferred that the permeate side gas circulation system includes the one or more pumps downstream of the outlet. While variable drive speed sweep pumps may be used, it is preferred that each sweep pump is operated at a single speed. Given this, it is further preferable that each sweep pump is a single speed pump. In alternative forms of the invention, the permeate side gas circulation system is a vacuum system, e.g. the system does not make use of a sweep gas circulation system, but is instead run under negative pressure.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a photograph of a refrigeration panel of a refrigerated shipping container.

FIG. 2 is a schematic of a membrane separation system for installation into a refrigerated shipping container.

FIG. 3 is a schematic illustrating one embodiment of the membrane separation system.

FIG. 4 is a schematic of a gas flow balance through a membrane filtration unit.

FIG. 5 is a schematic showing operation of the system under (a) a neutral pressure differential between the internal and external environments, and (b) positive pressure differential between the internal and external environments.

FIG. 6 is a schematic showing a membrane separation system of the invention installed in a container.

FIG. 7 is a graph showing flows (Q SLPM) over time measured using the system shown in FIG. 6 in two modes—the first mode (denoted ‘standard operation’) does not involve the addition of ambient air and the second mode (denoted ‘hybrid operation’) operated according to the invention.

FIG. 8 is a graph showing pressure (kPa) at various points of the system shown in FIG. 6 over time in the same two operation modes as described for FIG. 7.

FIG. 9 is a graph comparing CO₂ removal over time across operation of the system shown in FIG. 6 in the first versus the second mode as described for FIG. 7.

### DETAILED DESCRIPTION OF THE EMBODIMENTS

The invention relates to a method of, and apparatus for, controlling gas composition within a refrigerated container, such as to extend the life of perishable goods during transport within the refrigerated container. hi particular, the inventors have devised a way to enhance the energy efficiency and storage capabilities of a refrigerated transport container by: blending a first air stream withdrawn from an internal environment within the refrigerated shipping container with a second air stream obtained from an ambient environment external to the shipping container to form a blended air stream, passing this blended air stream to a separation membrane having greater relative selectivity for CO₂ and O₂ than N₂ to provide an N₂-rich gas stream, and then returning N₂ rich gas stream to the internal environment.

Respiring produce produces CO₂ which needs to be removed from the internal environment of the refrigerated shipping container to preserve the freshness of the respiring produce. Such respiring produce typically includes fruit, vegetables, plants, seedlings, plant materials, and the like.

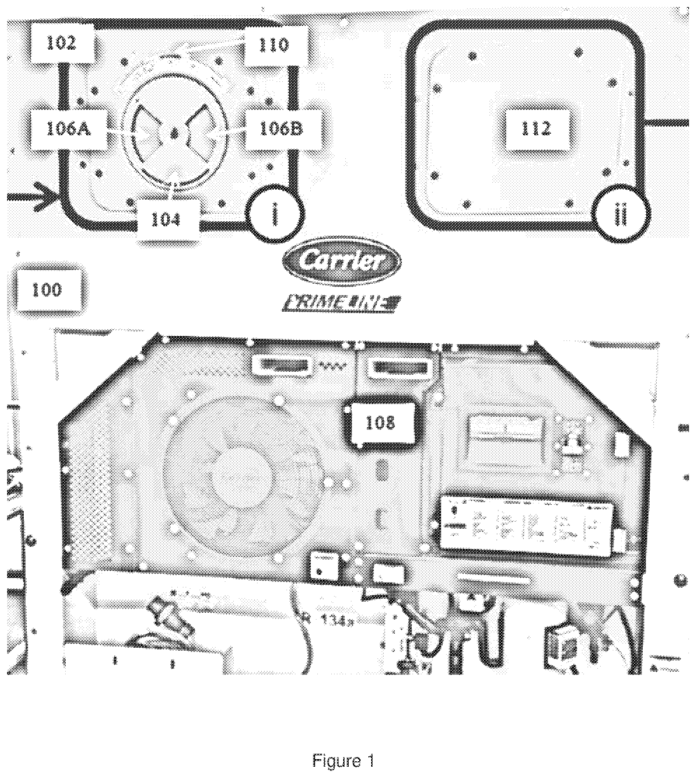

A refrigeration panel 100 of a reefer is illustrated in FIG. 1. The standard refrigeration panel 100 includes an air vent 102 which has two openings that define an inlet and an outlet (not shown). A rotatable vent cover 104 is located over the air vent 102, and this rotatable vent cover 104 can be rotated to open, close, or adjust the size of the inlet and outlet in the air vent 102 for the purpose of fresh air exchange. In FIG. 1, the rotatable vent cover 104 is shown in the closed position. However, the rotatable vent cover 104 includes two openings 106A and 106B which correspond with the openings (not shown) in the air vent 102. The refrigeration panel also includes a refrigeration system 108 for cooling air within the reefer.

The vent cover 104 includes gradations 110 which relate the size of the inlet and outlet openings to a corresponding fresh air exchange rate during standard operation. Larger inlet and outlet openings provide for a greater fresh air exchange rate. The fresh air exchange (and thus the size of the inlets and outlets) is dependent on the respiration rate of the respiring product. That is, respiring products that have a high respiration rate require a greater fresh air exchange rate than respiring products with a low respiration rate. At this point, it is important to note that if the reefer is intended for climate controlled operation, then the reefer is sealed by removing the rotatable vent cover 104, and installing a climate controller and valves over the vent openings to seal the vent. As a result, a sealed climate controlled reefer does not include a permanently open vent.

During the unsealed storage and/or transport of respiring produce, the respiring produce consumes oxygen and produces carbon dioxide. If the oxygen levels and carbon dioxide levels fall outside of a particular range, the quality of the respiring produce can rapidly deteriorate. To address this, and as alluded to above, the rotatable vent cover 104 is typically adjusted (by rotation) so as to provide inlet and outlet openings of a suitable size to permit an appropriate rate of gas exchange between the outside environment and the internal environment within the reefer to maintain suitable oxygen and carbon dioxide levels. The required rate of gas exchange is determined from the respiration rate of the respiring produce (being dependent on the type of respiring produce), and the appropriately sized opening in the air vent 102 is selected (e.g. by way of a lookup table) to provide the required rate of gas exchange.

The gas exchange process generally results in cool CO₂-rich, O₂-lean air from within the reefer being exchanged for air at ambient temperature and composition. This is advantageous in that CO₂ is removed from the system. However, there are several issues associated with introducing fresh air into the system. Firstly, introducing air at ambient temperature introduces heat energy into the system, and raises the internal temperature with the reefer. Increasing the temperature has a deleterious effect on the respiring produce. Thus, the refrigeration system 108 must remove this additional energy that has been introduced into the reefer. Secondly, introducing fresh air replenishes the oxygen lost to respiration. Replenishing this lost oxygen maintains the rate of respiration and thus also contributes to the degradation of the respiring produce.

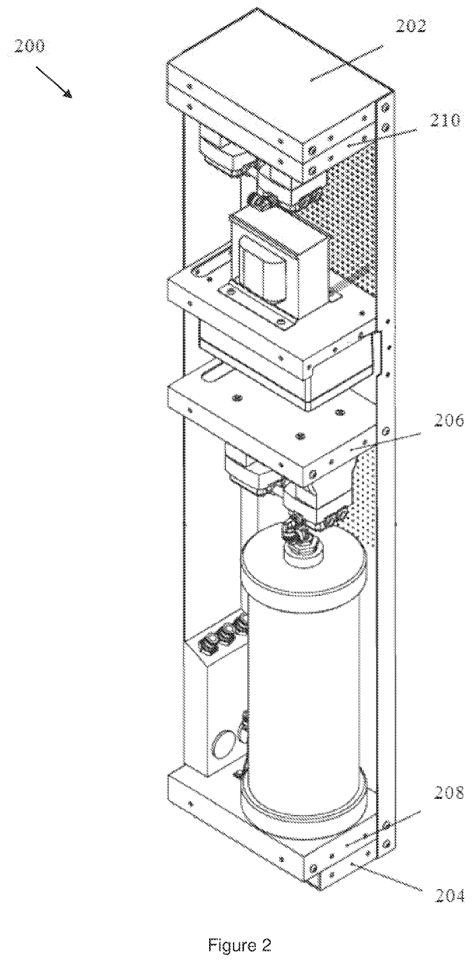

The inventors have included a membrane separation system according to aspects of the present invention into the refrigeration panel 100 of the reefer. FIG. 2 provides a schematic of a membrane separation system 200. The membrane separation system 200 includes a top bracket 202 and a bottom bracket 204 for mounting the system 200 inside a reefer. The system 200 further includes a circulation system that includes at least a lumen pump 206 for drawing a blended air flow obtained from (i) the internal environment of the reefer (e.g. ostensibly a CO₂-rich air stream), and (ii) ambient air from an external environment outside the reefer. This blended air flow is subjected to a membrane separation process where a portion of the CO₂ and O₂ is removed to provide an N₂-rich retentate stream that is fed back into the reefer.

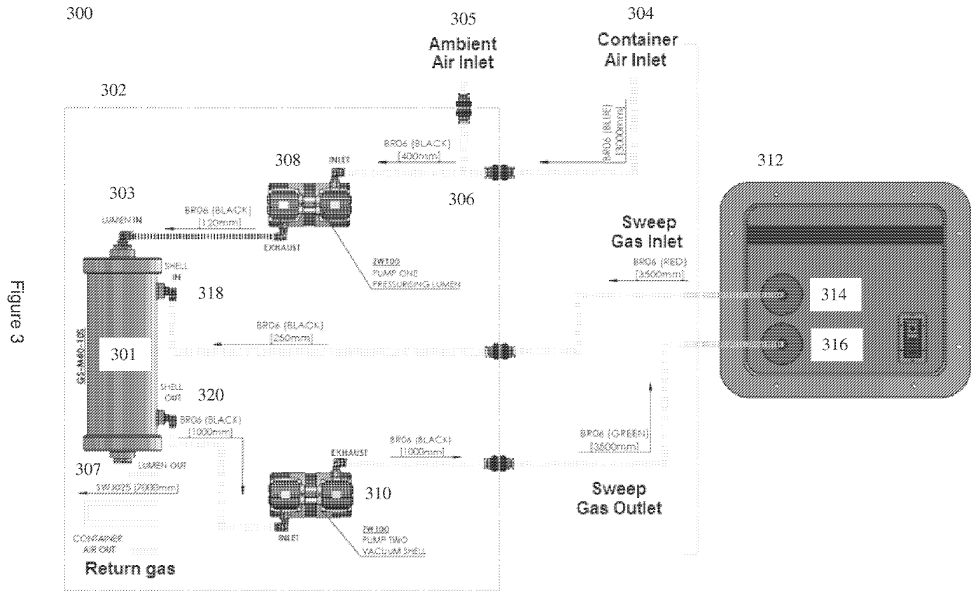

The system 200 also includes a sweep pump assembly 210 for providing a stream of sweep gas (ambient air) on the permeate side of the membrane 208 such that the CO₂ and O₂ that passes across the membrane from the retentate side of the membrane 208 to the permeate side of the membrane is entrained in the sweep gas. As part of installing the membrane separation system 200, blank panel 112 of the refrigeration panel 100 is removed and replaced with a membrane scrubber panel (see item 312 of FIG. 3) which includes an air inlet 314 and air outlet 316 for the sweep gas.

The membrane system 200 can be operated to reduce or completely offset the volume of gas that would otherwise need to be introduced through the vent in response to the removal of CO₂ and O₂ by the membrane separation system 200.

The cooled CO₂-rich air within the reefer is blended with ambient air and cycled through the membrane system (such as at a pre-set rate determined based on a characteristic of the respiring produce) to remove a portion of the CO₂ and O₂ from the blended air. Sufficient ambient air can be added such that the portion of CO₂ and O₂ removed from the cooled CO₂-rich air is effectively offset by additional N₂ that is introduced with the blended air. In this way, the N₂ rich stream is fed back into the reefer at the same flow rate as the cooled CO₂-rich air stream that is withdrawn from the reefer. The result is that the internal environment within the reefer has a N₂ vol % that is greater than ambient air (e.g. greater than 78 vol % on a dry air basis) and an O₂ vol % that is lower than ambient air (e.g. lower than 21 vol % on a dry air basis). The reduced O₂ content means that respiration is inhibited (which lowers the rate of CO₂ production), and thus lowers the electrical load required by the membrane separation and refrigeration systems.

Notwithstanding the above, the amount of ambient air blended with the CO₂-rich air to form the blended air stream can be controlled such that: (i) the flow rate of the N₂-rich air returned to the reefer is lower than the flow rate of the cooled CO₂-rich air withdrawn from the reefer, in which case some external air will leak into the reefer such as through a vent—this operating strategy may be useful if an increase in the O₂ vol % is required; (ii) the flow rate of the N₂-rich air returned to the reefer is the same as the flow rate of the cooled CO₂-rich air withdrawn from the reefer, in which case effectively no air exchange will occur between the internal environment of the reefer and the ambient air outside the reefer—this is likely to be the most energy efficient manner of operating the reefer; or (iii) the flow rate of the N₂ rich air returned to the reefer is higher than the flow rate of the cooled CO₂-rich air withdrawn from the reefer, in which case internal air may leak out of the reefer such as through a vent—this will prevent outside air from leaking into the reefer.

A process flow diagram illustrating one embodiment of the membrane separation system 300 is provided in FIG. 3. The system 300 includes: a membrane scrubbing unit 302 including a hollow fibre membrane filtration unit 301, a lumen inlet 303 for receiving a blended gas formed from a first gas taken from the internal environment of a shipping container via inlet 304 and a second gas drawn from an ambient environment external to the shipping container via inlet 305, a T-connector 306 for merging the first and second air flows obtained from inlets 304 and 305, and a lumen outlet 307 for returning filtered gas to the internal environment of the shipping container; a lumen pump 308 for circulating gas from the internal environment of the shipping container and through a retentate side of the membrane scrubbing unit 302. The system 300 also includes a sweep gas assembly that includes: a sweep pump 310 for circulating sweep gas though a permeate side of the membrane scrubbing unit 302 via sweep gas inlet 318 and sweep gas outlet 320, wherein the sweep pump 310 is in gas communication with a scrubber panel assembly 312 having an ambient air inlet port 314 and an exhaust port 316.

This membrane separation system 300 is installed in a reefer as discussed in relation to FIG. 2. The operation of the system 300 of FIG. 3 is briefly described below.

During shipping and/or storage of refrigerated respiring produce, the respiring produce consumes oxygen and produces carbon dioxide. The skilled person will appreciate that the degree of refrigeration and the rates of oxygen consumption and carbon dioxide production depend on one or more characteristics of the respiring produce. As previously discussed, to minimise degradation of the respiring produce, the oxygen and carbon dioxide concentrations should be maintained at appropriate levels. In a standard reefer, the vent cover (e.g. item 104 of FIG. 1) is rotated to a particular sized opening to permit fresh air exchange at an appropriate rate to maintain the oxygen and carbon dioxide concentration at an appropriate level. However, in a reefer system including the membrane separation system 300, the membrane separation system 300 removes a portion of the carbon dioxide and oxygen from the internal environment of the reefer. This allows the use of no vent, a closed vent, or a smaller vent opening which reduces the leakage of fresh air into the reefer from the external environment, and thus minimises the loss of cool air and the introduction of heat energy from ambient fresh air. The reduced oxygen content within the reefer also inhibits respiration which may additionally reduce the energy required to operate the reefer.

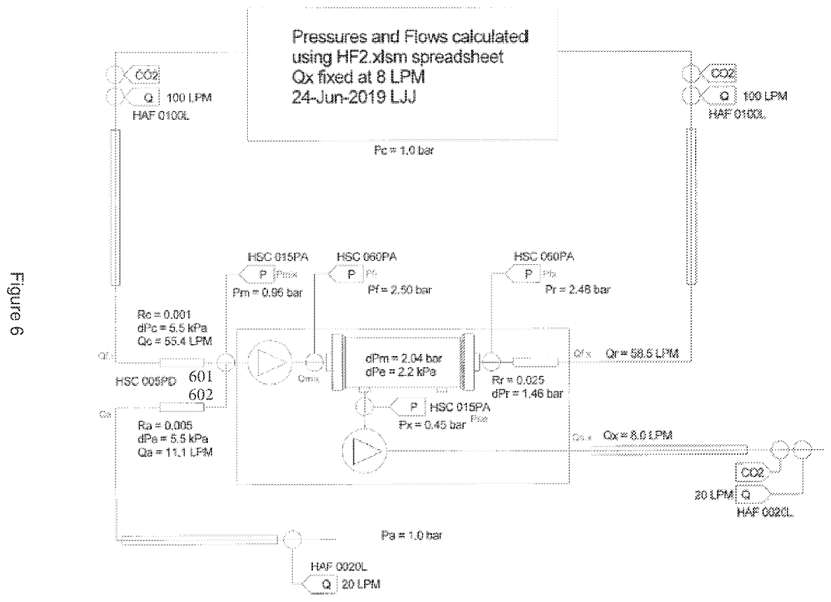

In operation, lumen pump 308 draws (i) a first air stream (e.g. cooled CO₂-rich, O₂-lean gas) from the internal environment of a reefer, and (ii) a second air stream from ambient air from outside the reefer. The first air stream and second air stream are blended to form a blended stream. The first air stream and second air stream may be blended in a number of different ways. FIG. 3 illustrates the use of a T-connector 306, however the skilled person will appreciate that other pipe connections may be used, such as a Y connector upstream of the lumen pump 308. Alternatively, other means known to those skilled in the art for merging or blending gas streams may be used. In such cases, the respective feedlines to inlets 304, 305 may include valves or other methods of flow restriction controllable or settable to provide the desired ratio of the first air stream to the second air stream. In some embodiments, feedlines to inlets 304 and/or 305 further comprise a restrictor (or resistor) to control the flow rate of the respective gas streams, such as restrictors 601 and 602 as shown in FIG. 6. The skilled addressee will appreciate that the first air stream may be blended with the second air stream in other ways and that such blending may occur downstream of lumen pump 308 but upstream of the hollow fibre membrane filtration unit 301 or at the point of entry to the hollow fibre membrane filtration unit 301.

The lumen pump 308 pushes this blended gas stream, under positive pressure, through the hollow fibre membrane filtration unit 301 via lumen inlet 304. Inside the membrane scrubbing unit 302, the blended gas is forced through lumens of a hollow fibre membrane separation unit. The membrane lumens are formed from a membrane material having greater relative selectivity for CO₂ and O₂ than N₂, which results in the selective transfer of CO₂ and O₂ across the lumen wall from a retentate side of the lumen to a permeate side of the lumen. This results in a N₂-rich gas stream (typically lean in CO₂ and O₂) on the retentate side of the lumen. The N₂-rich gas is then returned to the internal environment of the reefer via lumen outlet 306. In this embodiment, the downstream ends of the lumens are exposed directly to the lumen outlet 306 (e.g. there is no pump on the downstream side to draw the cooled air through the membrane system 300). Notwithstanding the above, the skilled addressee will appreciate that the membrane system may include an additional pump downstream of the lumen outlet 306 for drawing gas through the hollow fibre membrane filtration unit 301. In another form, the membrane separation system 300 does not include a lumen pump upstream of the lumen inlet 304, and instead includes a lumen pump downstream of the lumen outlet 306 to draw the blended gas through the hollow fibre membrane filtration unit 301 under negative pressure.

The sweep gas assembly provides a sweep gas (e.g. ambient air drawn from outside of the reefer) to the permeate side of the hollow fibre membrane filtration unit 301. During operation, sweep gas pump 310 applies a negative pressure to the sweep gas assembly to draw ambient air from outside the reefer via inlet port 314 and into the hollow fibre membrane filtration unit 301 via sweep gas inlet 318. The sweep gas is drawn through the sweep gas inlet 318 and along the permeate side of the membrane lumens to entrain and selectively remove CO₂ and O₂ that has filtered across the membrane lumens from the blended gas on the retentate side of the lumen resulting in a CO₂- and O₂-rich sweep gas. The CO₂- and O₂-rich sweep gas is then drawn through sweep gas outlet 320, through sweep gas pump 310, and then discharged under positive pressure through exhaust port 316 to an environment outside the reefer.

It will be appreciated that a variety of different membranes may be used in the membrane gas scrubber. In some embodiments, the membrane comprises a material selected from one or more of the group consisting of polydimethylsiloxane (PDMS), cellulose acetate, polyethersulfone, poly(benzoxazole-co-imide), poly(phthalazinone ether sulfone ketone) (PPESK), a polyimide (eg matrimid, 6FDA-p-PDA, etc.), polyetheretherketone (PEEK) and polysolfone.

The thickness of the membrane layer will vary depending at least in part on the membrane material selected. In some embodiments, the minimum thickness of the membrane may be at least about 0.01 μm, 0.05 μm or about 0.1 μm. The maximum thickness of the membrane may be not more than about 70 μm, 50 μm or 35 μm. The membrane thickness may be from any of these minimum values to any of these maximum values, for example, from about 0.01 μm to about 70 μm or about 0.1 to about 35 μm.

The total surface area of the membrane will also vary depending on the material selected, its thickness and the rate of CO₂ removal required. In some embodiments, the minimum total surface area of the membrane may be at least about 0.01 m² or about 0.02 m². The maximum total surface area of the membrane may be not more than about 100 m², 50 m², 20 m², 15 m² or 11 m². Membranes with larger total surface area may not be suitable due to space constraints imposed by the container. The total surface area of the membrane may be from any of these minimum values to any of these maximum values, for example, from about 0.01 m² to about 100 m² or about 0.02 m² to about 15 m².

Membranes contemplated include an overall permeability for CO₂ of about 3000 Barrer. These membranes may have a thickness of about 35 μm to 45 μm. Preferred membranes have about 3100 Barrers of permeability for CO₂ and may be about 40 μm in thickness. This is a very high permeability. However, other membrane materials are contemplated to be useful. One type of suitable membrane for use with preferred embodiments of the present invention is manufactured from Polydimethylsiloxane (PDMS), which has moderate selectivity to CO₂, at about between 4 and 5, and a CO₂/N₂ selectivity of between about 10 and 11. Other membranes, including non-silicon membranes, may also be used. In other embodiments, the invention uses cellulose acetate as the membrane material, which has an overall permeability for CO₂ of 6.3 Barrer. This is a large difference, but gas transfer can be improved by altering the thickness of the membrane or by increasing the total surface area of the membrane.

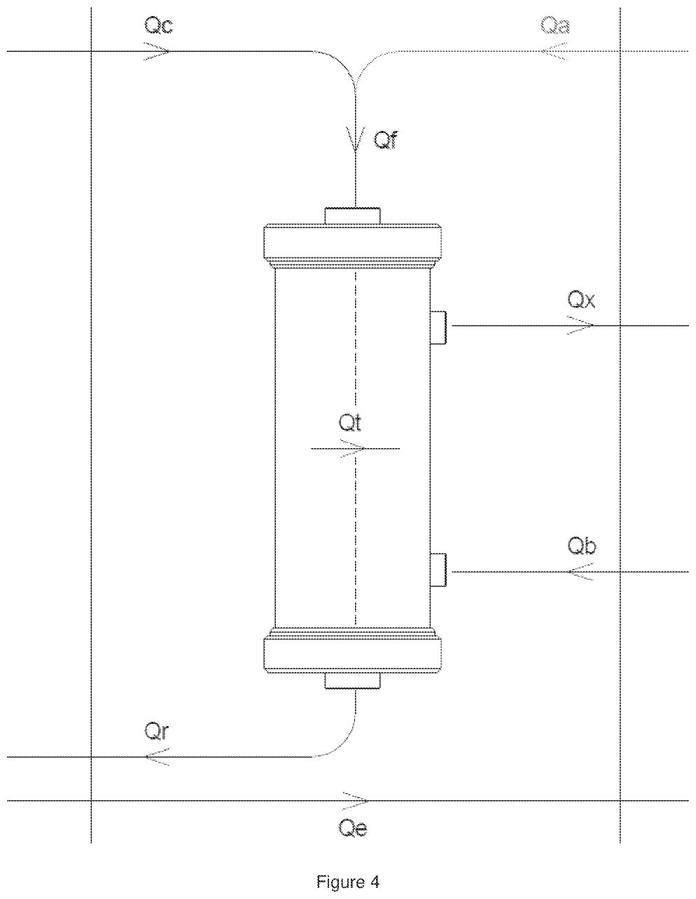

FIG. 4 is a schematic providing a flow balance through a membrane filtration unit according to an embodiment of the invention, such as the membrane filtration unit 301 of FIG. 3. In FIG. 3 Q represents the mass flow rate of various gas streams as follows: Qc is container feed flow, Qa is ambient air feed flow, Qf is total feed flow, Qt is module transflow, Qb is the air sweep inlet flow (which is zero when operating in vacuum mode), Qx is the air sweep exhaust flow, and Qe is the total effective container flow. The following equations hold: Qf=Qc+Qa, Qr=Qf−Qt, Qx=Qb+Qt, and Qe=Qc−Qr.

When Qa=0, the membrane transflow will result in a decrease of container pressure, leading to makeup air flowing into the container from the ambient atmosphere (e.g. through a vent). Increasing Qa (e.g. Qa>0) to the module lumen flow (e.g. providing a blended flow) alters the overall effective flow from the container to ambient atmosphere, and thus reduces the makeup flow required through the vent to stabilize the container pressure. Also, as discussed previously, adding Qa means that Qr will be nitrogen enriched relative to ambient atmosphere due to the higher permeability of the membrane for CO₂ and O₂ relative to N₂.

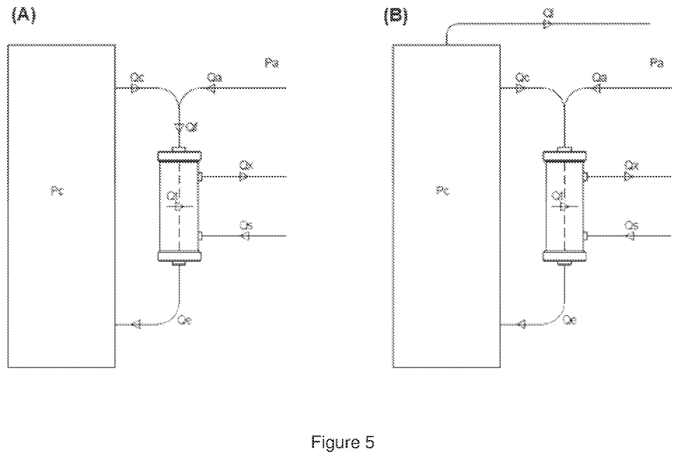

FIG. 5A and FIG. 5B provide further illustrative examples of arrangements according to aspects and/or embodiments of the invention.

FIG. 5A provides an example in which the exchanger operation results in an outflow of CO₂ enriched gas from the container Qx using a vacuum sweep (e.g. no sweep gas, Qs is set to zero). In this mode, the operation of the exchanger results in an outflow of CO₂ enriched gas (Qx). Ambient atmosphere is mixed with the CO₂ enriched gas from the container Qc upstream of the membrane exchanger to compensate for the membrane exchanger outflow. In this example the container pressure is balanced such that there is no differential pressure between the internal environment within the container and the ambient environment. In this way, all makeup air is introduced via Qa to the container. When operated in this way, once equilibrium has been reached, Pc is equal to Pa.

FIG. 5B provides an example in which the exchanger operation results in an outflow of CO₂ enriched gas from the container Qx using a vacuum sweep (e.g. no sweep gas, Qs is set to zero). Operation of the membrane exchanger in this example provides an N₂-rich flow to the container (Qe). This N₂-rich flow results in the container pressure being greater than the ambient pressure, causing egress of CO₂-rich air from the internal environment to the external environment via any container leaks that may exist (Ql). When operated in this way, once equilibrium has been reached, Qe equals the sum of Ql and Qc, and Pc is greater than than Pa.

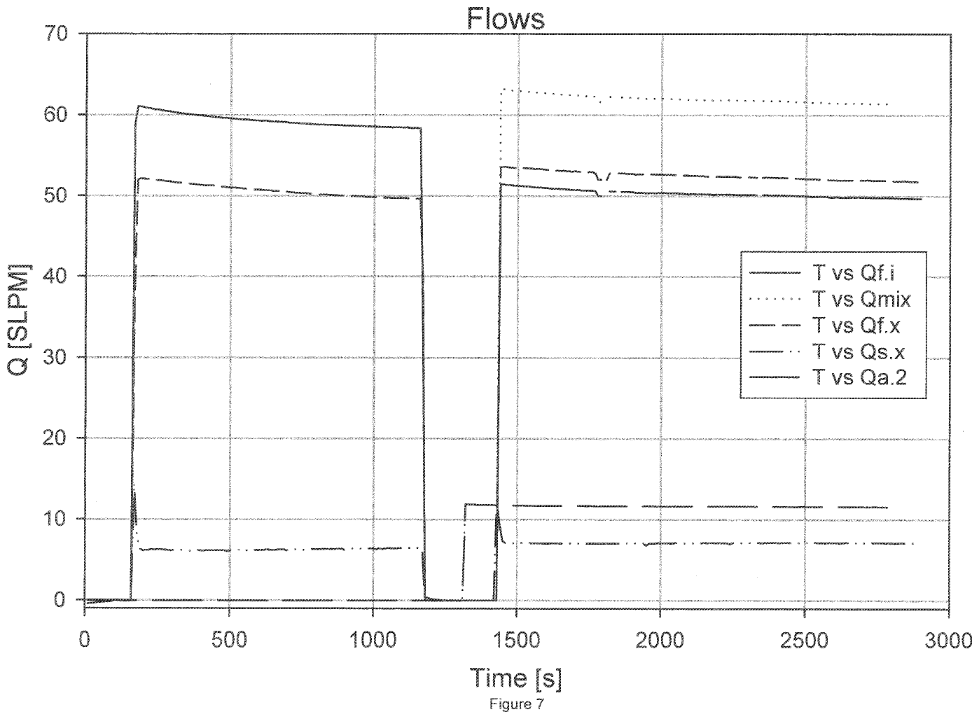

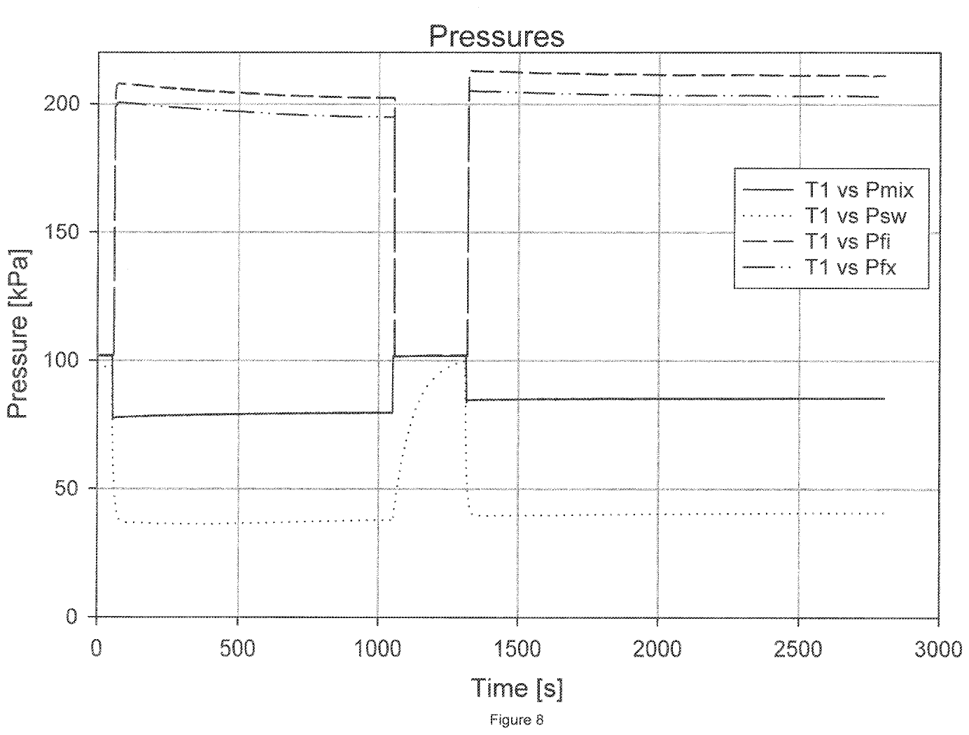

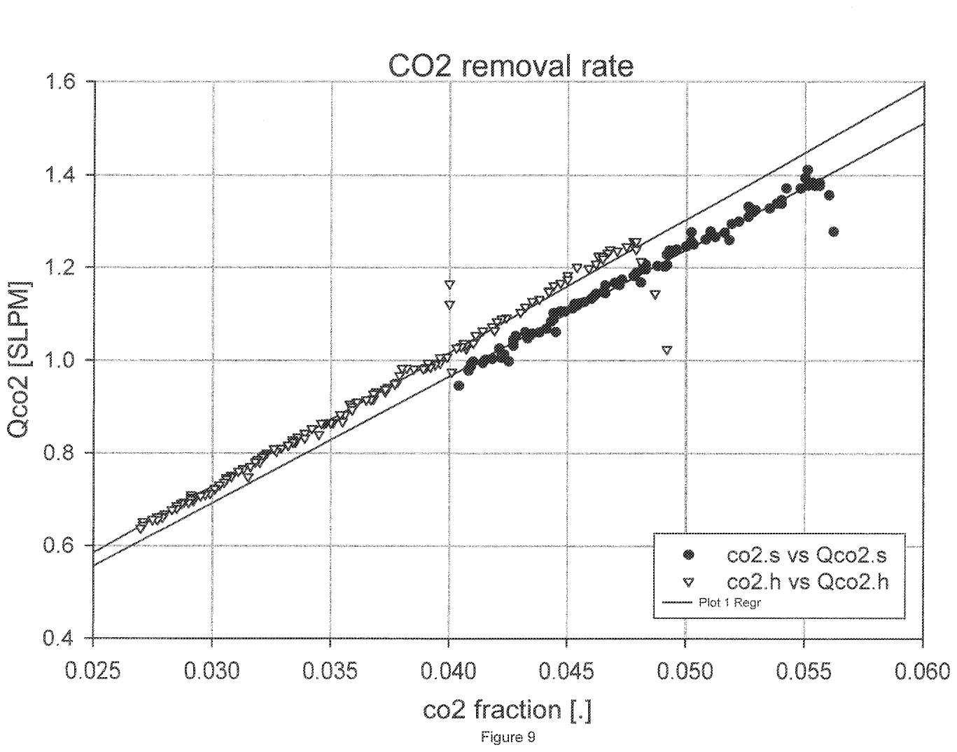

FIG. 6 provides an example of a membrane system of the invention configured within a test container. The schematic shows pressures (denoted P) and flows (denoted Q) at various points before and after the membrane system when the system was in use. In FIG. 6 Q represents the mass flow rate of various gas streams as follows: Qc is container feed flow, Qfi is the initial container feed flow, Qfx is the air flow for the N₂ enriched airstream, Qa is ambient air feed flow, Qmix is the feed flow of the combined airstream from Qa and Qc, Qs.x is the airflow for the CO₂ enriched airstream, Qx is the air sweep exhaust flow, and Qr is the outlet flow of from the membrane system. In FIG. 6 P represents the pressure at various points of the system as follows: Pa is the pressure of the ambient air outside the container, Pc is the pressure of the air within the container, dPa is the pressure of the ambient air stream prior to entering the membrane system, dPc is the pressure of the container air stream prior to entering the membrane system, Pmix is the pressure of the combined air stream prior to entering the membrane system, Px is the pressure of the air sweep exhaust stream, and Pr is the pressure of the N₂ enriched air stream exiting the membrane system. This system can be operated in a similar manner to the operation of the system described in FIG. 3. Results from tests of this system are shown in FIGS. 7-9. These Figures show results from operation of the system in two modes, the first mode was operated for a first period (from about 200-1200 seconds) with only recirculated air from within the container (ie ‘standard operation’, wherein Qa was about zero) and the second mode was operated for a second period (from about 1400 seconds to the end of the experiment) where ambient airflow from outside the container is added (ie ‘hybrid operation, in a manner in accordance with the present invention, and similar to that described with reference to FIG. 5B above). FIG. 7 shows the flow results, FIG. 8 shows the pressure results and FIG. 9 shows a comparison of measures of CO₂ removal from each of the two modes of operation over time by comparing the flow rate of the CO₂-rich exhaust stream (the subscripts ‘s’ and ‘h’ used with reference to the plotted points referring to ‘standard operation’ and ‘hybrid operation’, respectively). These results indicate that operating the membrane system according to the invention provides a comparable CO₂ removal rate (within experimental error) and maintains desirable pressures within the container.

It will be understood that the invention disclosed and defined in this specification extends to all alternative combinations of two or more of the individual features mentioned or evident from the text or drawings. All of these different combinations constitute various alternative aspects of the invention.

### EXAMPLES

The below examples report steady state modeling results with the container under different pressure conditions, and with the desired oxygen concentration within the container set to 5 vol %.

The model is designed to simulate the operation of a shipping container transporting respiring produce, and calculate the equilibrium conditions for gas concentrations and container pressure given user specified inputs.

The overall method is to perform a total mass flow balance of all component gasses of the system being simulated to within a user specified tolerance (typically less than 1 μL/min imbalance).

The inputs into the model include elements relating to the shipping container, produce, and the gas exchange equipment. While most of these inputs will be known the skilled addressee, e.g. temperatures, pressures, produce respiration rates, valve and flow settings etc., the following information is provided below regarding modeling the following forms of leakage: (i) hydrodynamic leakage, (ii) diffusion leakage, and (iii) pumped leakage.

(i) Hydrodynamic leakage is the leakage measured in a standard leak test for an unpowered container. The hydrodynamic leakage represents the sum of all leaks in all areas of the container under a specific static pressure elevation. In operation the container evaporator fans produce a region of low pressure (upstream of the fans) and high pressure (downstream of the fans), while the pressure in the container near the doors is considered to be unchanged. For this reason, the simulation considers the container as three zones, where the leakage is calculated by the pressure difference between each zone and the external ambient pressure. The division is achieved by a weighting assigned to each zone.

(ii) Diffusion leakage is the leakage due to gas partial pressure differences. This is assumed to operate over the entire surface of the shipping container, and is determined by Fick's law.

(iii) Pumped leakage simulates the effect of a constant flow rate being pumped into or out of the shipping container.

Examples 1 to 3 report results with the refrigerated container running under negative pressure relative to the ambient environment with differential pressures of −70.5 Pa, −587 Pa, and −48.4 Pa corresponding to respiration rates of 6, 8, and 10 SLPM respectively. In each of these case there is an inflow to the container from the external environment through leakage, e.g. via the vents.

Examples 4 to 6 report results with the container running under positive pressure relative to the ambient environment with differential pressures of 26.5 Pa, 18.1 Pa, and 13.1 Pa corresponding to respiration rates of 6, 8, and 10 SLPM respectively. In each of these case there is an outflow from the container from the internal environment through leakage, e.g. via the vents.

Note: All flows reported in Examples 1 to 6 are in the sense of into the shipping container (negative flows are outflows).

### Example 1

TABLE 1
Modelling conditions

| | | |
|---|---|---|
| Af | 103446.362897 | [cm2] |
| ValveDC | 0.078038 | [fraction] |
| Pc | 101254.5 | [Pa] |
| dPc | −70.5 | [Pa] |

Note: In the table above: Af is the calculated area of the gas exchange module; ValveDC is the air exchange valve duty cycle at equilibrium; Pc is the pressure within the container at equilibrium, and dPc is the differential pressure between the container and atmosphere.

TABLE 2
Steady state results

| | O₂ | N₂ | CO₂ | Total |
|---|---|---|---|---|
| fc: | 0.05 | 0.88115 | 0.06885 | |
| Qr: | −2 | 0 | 2 | 0 |
| Qv1: | 1.57302 | 5.953392 | 0 | 7.526412 |
| Qv2: | −0.225962 | −3.982127 | −0.311149 | −4.519238 |
| Qe: | −0.540038 | −5.569547 | −1.597626 | −7.707211 |
| Qll: | 0.768077 | 2.906932 | 0 | 3.675009 |
| Qlh: | −0.066250 | −1.167516 | −0.091225 | −1.324991 |
| Qlz: | 0.491154 | 1.858865 | 0 | 2.350018 |
| Qt: | 0.000001 | −0.000001 | 0 | |

Note: In the table above: fc is the steady state gas composition within the container; Qr is the respiration flows; Qv1 and Qv2 are the flow rates through inlet and outlet valves on the vent; Qe is the gas exchanger scrubber flows; Qll, Qlh, and Qlz are estimates of low pressure leakage, high pressure leakage, and zero pressure leakage flows from zones within the refrigerated container; and Qt is the total flow. Flow values in SLPM.

### Example 2

TABLE 3
Modelling conditions

| | | |
|---|---|---|
| Af | 103446.362897 | [cm2] |
| ValveDC | 0.128744 | [fraction] |
| Pc | 101266.3 | [Pa] |
| dPc | −58.7 | [Pa] |

Note: In the table above: Af is the calculated area of the gas exchange module; ValveDC is the air exchange valve duty cycle at equilibrium; Pc is the pressure within the container at equilibrium, and dPc is the differential pressure between the container and atmosphere.

TABLE 4
Steady state results

| | O₂ | N₂ | CO₂ | Total |
|---|---|---|---|---|
| fc: | 0.05 | 0.873701 | 0.076233 | |
| Qr: | −2.66667 | 0 | 2.666667 | 0 |
| Qv1: | 2.525018 | 9.556409 | 0 | 12.08143 |
| Qv2: | −0.39939 | −6.97898 | −0.60947 | −7.98784 |
| Qe: | −0.51933 | −5.54961 | −1.94116 | −8.01011 |
| Qll: | 0.727138 | 2.751991 | 0 | 3.479129 |
| Qlh: | −0.07604 | −1.32879 | −0.11604 | −1.52087 |
| Qlz: | 0.409276 | 1.548982 | 0 | 1.958258 |
| Qt: | 0.000001 | 0 | −0.000001 | |

Note: In the table above: fc is the steady state gas composition within the container; Qr is the respiration flows; Qv1 and Qv2 are the flow rates through inlet and outlet valves on the vent; Qe is the gas exchanger scrubber flows; Qll, Qlh, and Qlz are estimates of low pressure leakage, high pressure leakage, and zero pressure leakage flows from zones within the refrigerated container; and Qt is the total flow. Flow values in SLPM.

### Example 3

TABLE 5
Modelling conditions

| | | |
|---|---|---|
| Af | 103446.362897 | [cm2] |
| ValveDC | 0.192444 | [fraction] |
| Pc | 101276.6 | [Pa] |
| dPc | −48.4 | [Pa] |

Note: In the table above: Af is the calculated area of the gas exchange module; ValveDC is the air exchange valve duty cycle at equilibrium; Pc is the pressure within the container at equilibrium, and dPc is the differential pressure between the container and atmosphere.

TABLE 6
Steady state results

| | O₂ | N₂ | CO₂ | Total |
|---|---|---|---|---|
| fc: | 0.05 | 0.863392 | 0.086608 | |
| Qr: | −3.33333 | 0 | 3.333333 | 0 |
| Qv1: | 3.679147 | 13.92443 | 0 | 17.60357 |
| Qv2: | −0.63009 | −10.8803 | −1.09142 | −12.6018 |
| Qe: | −0.6588 | −5.47126 | −2.09519 | −8.22524 |
| Qll: | 0.690926 | 2.614939 | 0 | 3.305865 |
| Qlh: | −0.08471 | −1.4627 | −0.14673 | −1.69414 |
| Qlz: | 0.336852 | 1.274879 | 0 | 1.61173 |
| Qt: | −1E−06 | 0.000001 | 0 | |

Note: In the table above: fc is the steady state gas composition within the container; Qr is the respiration flows; Qv1 and Qv2 are the flow rates through inlet and outlet valves on the vent; Qe is the gas exchanger scrubber flows; Qll, Qlh, and Qlz are estimates of low pressure leakage, high pressure leakage, and zero pressure leakage flows from zones within the refrigerated container; and Qt is the total flow. Flow values in SLPM.

### Example 4

TABLE 7
Modelling conditions

| | | |
|---|---|---|
| Af | 103446.362897 | [cm2] |
| ValveDC | 0.036992 | [.] |
| Pc | 101351.5 | [Pa] |
| dPc | 26.5 | [Pa] |

Note: In the table above: Af is the calculated area of the gas exchange module; ValveDC is the air exchange valve duty cycle at equilibrium; Pc is the pressure within the container at equilibrium, and dPc is the differential pressure between the container and atmosphere.

TABLE 8
Steady state results

| | O₂ | N₂ | CO₂ | Total |
|---|---|---|---|---|
| fc: | 0.05 | 0.877812 | 0.072188 | |
| Qr: | −2 | 0 | 2 | 0 |
| Qv1: | 0.558064 | 2.112097 | 0 | 2.670161 |
| Qv2: | −0.1596 | −2.80193 | −0.23042 | −3.19195 |
| Qe: | 1.362551 | 2.418939 | −1.49349 | 2.288005 |
| Qll: | 0.430215 | 1.628231 | 0 | 2.058446 |
| Qlh: | −0.14708 | −2.58213 | −0.21234 | −2.94155 |
| Qlz: | −0.04416 | −0.7752 | −0.06375 | −0.88311 |
| Qt: | −0.000001 | 0 | 0.000001 | |

Note: In the table above: fc is the steady state gas composition within the container; Qr is the respiration flows; Qv1 and Qv2 are the flow rates through inlet and outlet valves on the vent; Qe is the gas exchanger scrubber flows; Qll, Qlh, and Qlz are estimates of low pressure leakage, high pressure leakage, and zero pressure leakage flows from zones within the refrigerated container; and Qt is the total flow. Flow values in SLPM.

### Example 5

TABLE 9
Modelling conditions

| | | |
|---|---|---|
| Af | 103446.362897 | [cm2] |
| ValveDC | 0.087553 | [fraction] |
| Pc | 101343.1 | [Pa] |
| dPc | 18.1 | [Pa] |

Note: In the table above: Af is the calculated area of the gas exchange module; ValveDC is the air exchange valve duty cycle at equilibrium; Pc is the pressure within the container at equilibrium, and dPc is the differential pressure between the container and atmosphere.

TABLE 10
Steady state results

| | O₂ | N₂ | CO₂ | Total |
|---|---|---|---|---|
| fc: | 0.05 | 0.866307 | 0.083693 | |
| Qr: | −2.666667 | 0 | 2.666667 | 0 |
| Qv1: | 1.364879 | 5.165641 | 0 | 6.53052 |
| Qv2: | −0.368658 | −6.387419 | −0.61709 | −7.37316 |
| Qe: | 1.381335 | 2.433526 | −1.76454 | 2.050319 |
| Qll: | 0.459399 | 1.738682 | 0 | 2.198081 |
| Qlh: | −0.140096 | −2.427321 | −0.2345 | −2.80192 |
| Qlz: | −0.030192 | −0.523109 | −0.05054 | −0.60384 |
| Qt: | 0 | −0.000001 | 0.000001 | |

Note: In the table above: fc is the steady state gas composition within the container; Qr is the respiration flows; Qv1 and Qv2 are the flow rates through inlet and outlet valves on the vent; Qe is the gas exchanger scrubber flows; Qll, Qlh, and Qlz are estimates of low pressure leakage, high pressure leakage, and zero pressure leakage flows from zones within the refrigerated container; and Qt is the total flow. Flow values in SLPM.

### Example 6

TABLE 11
Modelling conditions

| | | |
|---|---|---|
| Af | 103446.362897 | [cm2] |
| ValveDC | 0.138788 | [fraction] |
| Pc | 101338.1 | [Pa] |
| dPc | 13.1 | [Pa] |

Note: In the table above: Af is the calculated area of the gas exchange module; ValveDC is the air exchange valve duty cycle at equilibrium; Pc is the pressure within the container at equilibrium, and dPc is the differential pressure between the container and atmosphere.

TABLE 12
Steady state results

| | O₂ | N₂ | CO₂ | Total |
|---|---|---|---|---|
| fc: | 0.05 | 0.859337 | 0.090662 | |
| Qr: | −3.333333 | 0 | 3.333333 | 0 |
| Qv1: | 2.204618 | 8.343792 | 0 | 10.54841 |
| Qv2: | −0.575548 | −9.891789 | −1.04361 | −11.5109 |
| Qe: | 1.384939 | 2.452461 | −2.00384 | 1.833559 |
| Qll: | 0.476989 | 1.805255 | 0 | 2.282245 |
| Qlh: | −0.135888 | −2.335469 | −0.2464 | −2.71776 |
| Qlz: | −0.021776 | −0.374251 | −0.03948 | −0.43551 |
| Qt: | 0.000001 | | −0.000001 | |

Note: In the table above: fc is the steady state gas composition within the container; Qr is the respiration flows; Qv1 and Qv2 are the flow rates through inlet and outlet valves on the vent; Qe is the gas exchanger scrubber flows; Qll, Qlh, and Qlz are estimates of low pressure leakage, high pressure leakage, and zero pressure leakage flows from zones within the refrigerated container; and Qt is the total flow. Flow values in SLPM.

1. A method for controlling the atmosphere within a refrigerated shipping container containing respiring produce, the method including:
blending a first air stream withdrawn from an internal environment within the refrigerated shipping container with a second air stream obtained from an ambient environment external to the shipping container to form a blended air stream;
subjecting the blended air stream to a membrane separation process using a separation membrane having greater relative selectivity for CO₂ and O₂ than N₂ to provide an N₂-rich gas stream; and
returning the N₂-rich gas stream to the internal environment.

2. The method of claim 1, wherein the first air stream is a cooled CO₂-rich air stream.

3. The method of claim 1, wherein the N₂-rich gas stream is lean in CO₂ and O₂.

4. The method of claim 1, wherein the step of subjecting the blended air stream to the membrane separation process includes:
contacting the blended air stream with the membrane to produce a CO₂-, O₂-rich permeate stream and a retentate stream that is the N₂-rich gas stream; and
exhausting the CO₂-, O₂-rich permeate stream to the external environment.

5. The method of claim 1, wherein the first air stream and the second air stream are blended in a ratio of from about 99:1 to about 8:1.

6. The method of claim 5, wherein the ratio is from about 95:1 to about 8.5:1.

7. The method of claim 1, wherein the second air stream has a volumetric flowrate that is sufficient that a volumetric flow rate of the N₂-rich gas stream is from 80% and up to 120% of a volumetric flow rate of the first air stream.

8. The method of claim 7, wherein the volumetric flow rate of the N₂-rich stream is from 100% and up to 110% of the volumetric flow rate of the first air stream.

9. The method of claim 1, wherein the membrane has a CO₂:N₂ selectivity ratio of at least 5:1

10. The method of claim 1, wherein the membrane has an O₂:N₂ selectivity ratio of at least 1.5:1.

11. The method of claim 1, wherein the membrane has a CO₂:O₂ selectivity ratio of at least 5:2.

12. The method of claim 1, wherein the refrigerated shipping container: (i) does not include a vent, or (ii) is operated with the vent set to a substantially closed position, or (iii) is operated with the vent set to a position such that air flow through the vent is less than that required to replace the first air stream that is withdrawn from the internal environment.

13. A refrigerated shipping container configured to be operated according to the method of claim 1.

14. A refrigerated shipping container configured to transport respiring produce, the refrigerated shipping container including:
a gas membrane separation module including:
a first gas inlet open to an internal environment within the refrigerated shipping container configured to draw a first air stream from the internal environment;
a second gas inlet open to an ambient environment external to the refrigerated shipping container and configured to draw a second air stream from the ambient environment;
a membrane unit including:
a membrane having greater relative selectivity for CO₂ and O₂ than N₂ and configured to provide an N₂-rich gas stream;
an inlet to the membrane configured to receive a blended gas stream from the first gas inlet and the gas inlet; and
an outlet from the membrane open to the internal environment configured to return the N₂ rich gas stream to the internal environment.

15. The refrigerated shipping container of claim 14, further including:
gas circulation means configured to:
draw the first air stream through the first inlet,
draw the second gas stream through the second inlet,
contact the blended air stream with the membrane, and
return the N₂-rich gas stream to the internal environment.

16. The refrigerated shipping container of claim 13, wherein the refrigerated shipping container: (i) does not include a vent, or (ii) includes a vent set to a substantially closed position, or (iii) includes a vent configured to an open position such that air flow through the vent is less than that required to replace the first air stream that is withdrawn from the internal environment.

17. A gas membrane separation module, the gas membrane separation module including:
a mount for installing the gas membrane separation module into or onto a refrigerated shipping container;
a first gas inlet open to an internal environment within the refrigerated shipping container configured to draw a first air stream from the internal environment;
a second gas inlet open to an ambient environment external to the refrigerated shipping container and configured to draw a second air stream from the ambient environment;
a membrane unit including:
a membrane having greater relative selectivity for CO₂ and O₂ than N₂ and configured to provide an N₂-rich gas stream;
an inlet to the membrane configured to receive a blended gas stream formed from the first air stream and the second air stream; and
an outlet from the membrane open to the internal environment configured to return the N₂-rich gas stream to the internal environment.

18. The gas membrane separation module of claim 17, when used in a refrigerated shipping container.

19. A method including installing the gas separation module of claim 17 into or onto a refrigerated shipping container.
